(19) United States
(12) Patent Application Publication
(10) Pub. No.: US 2025/0385848 A1
(43) Pub. Date: Dec. 18, 2025

(54) QUICK CASE TYPE SELECTOR

(71) Applicant: ServiceNow, Inc., Santa Clara, CA (US)

(72) Inventors: Sanjay Gupta, Saratoga, CA (US); Vytesh Ramesh, Fremont, CA (US); Shilpa Shree Rajashekara, Sunnyvale, CA (US); Kavita Waldia, San Jose, CA (US); Dikesh Kumar, Hyderabad (IN); Amanda Nichole Chaffee, Fremont, CA (US)

(21) Appl. No.: 18/741,584

(22) Filed: Jun. 12, 2024

Related U.S. Application Data
(63) Continuation of application No. 17/153,566, filed on Jan. 20, 2021, now abandoned.

(51) Int. Cl. H04L 41/5025; G06Q 10/0631; H04L 41/22

(52) U.S. Cl. CPC H04L 41/5025; G06Q 10/063112; H04L 41/22

(57) ABSTRACT

A system includes one or more client instances hosted by a platform, in which the one or more client instances includes an agent port. A client may submit a request for a resolution to an agent. The agent portal may receive the request, display a subset of one or more sub-case type selections in response to receiving the request, and receive an indication of a selected sub-case type selection of the one or more sub-case type selection to initiate one or more processes to resolve the request. In response to selecting the sub-case type selection, the system may automatically select related sub-case type selections to resolve the request.

### BACKGROUND

The present disclosure relates generally to extending data from a case generated in support of a customer to associated cases and/or sub-cases.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Enterprise networks, systems, and other related processes may utilize software and hardware resources, often implemented on multiple, inter-connected devices, to conduct activities or otherwise perform the activities of various enterprise operations. In some situations, provisioning, configuring, expanding, maintaining, and/or normal use of such resources, as well as related systems, may give rise to an agent of the enterprise being tasked with completing one or more tasks. In other instances, a client of the enterprise may communicate with the agent and request a resolution for an issue, or the client may provide products and/or services to customers of the client who may in turn request a resolution of an issue related to the products and/or service. Specifically, the customer may contact the agent through chat, in person, by email, and/or by calling a customer service number. The customer may contact the agent through any of these methods to resolve the request, and the agent may generate a case to provide the appropriate resolution.

However, the case may be associated with other cases and/or sub-cases related to the subject matter of the case (e.g., the issue, interest, or concern raised by the customer) and/or the customer themselves, and these other cases and/or sub-cases may also need to be resolved. By way of example, in a banking context, the customer may request a conversation with an agent to report a lost credit card. The agent may open a case related to the customer and the lost credit card. The resolution for the case may involve canceling the card or placing it on hold for a predetermined time period prior to canceling.

However, upon canceling the card, the customer may need a replacement card. As such, the agent may generate an additional case to issue the replacement card. In some instances, the customer may contact another agent at another time frame for requesting the replacement card and the agent may generate the additional case. Often, the agent may input the same data or information when resolving these related sub-cases (e.g., sub-case for canceling the credit card and sub-case for issuing a replacement card) associated with the case of lost credit card.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

The present approach relates to systems and methods for enabling selection of a case type selection or a sub-case type selection for a task, in a single step or fewer steps than would be utilized when the technique is not employed. The systems and methods disclosed herein provide efficient resolution of multiple sub-case type selections and related sub-case type selections, and their corresponding processes, so as to reduce or eliminate the time used to select an initial category type and/or case type. The quick case type selection may further reduce the time to input the same information for the processes associated with the sub-case type selection and the related sub-case type selections. The systems and methods may also efficiently provide a subset of the possible or available sub-case type selections based on conditions, such as relevance or access rights for an organization group to the sub-case type selections, access rights for an agent identifier (ID) (e.g., agent ID) to the sub-case type selections, customer account information, and so forth. These conditions may be dynamically updated to facilitate creating different or a limited set of sub-case type selections based on the set conditions.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a block diagram of an embodiment of a multi-instance cloud architecture in which embodiments of the present disclosure may operate;

FIG. 2 is a schematic diagram of an embodiment of a multi-instance cloud architecture in which embodiments of the present disclosure may operate;

FIG. 3 is a block diagram of a computing device utilized in a computing system that may be present in FIG. 1 or 2, in accordance with aspects of the present disclosure;

FIG. 4 is a block diagram illustrating an embodiment in which a virtual server supports and enables the client instance, in accordance with aspects of the present disclosure;

FIG. 5 is a flow diagram of extending information from a case type selection to sub-case type selections, in accordance with aspects of the present disclosure;

FIG. 6 is a process flow diagram of generating field mappings for the sub-case type selections, in accordance with aspects of the present disclosure;

FIG. 7 is a flow diagram of a case base table extending information from a case type selection to sub-case type selections, in accordance with aspects of the present disclosure;

FIG. 8 is a block diagram a graphical user interface in an administrative view illustrating associating a case type selection to sub-case type selections of the case base table of FIG. 7, in accordance with aspects of the present disclosure;

FIG. 9 is a block diagram of the graphical user interface illustrating setting fields values for the case type selections of the case base table of FIG. 8, in accordance with aspects of the present disclosure;

FIG. 10 is a process flow diagram for resolving multiple sub-case type selections based on information extended from the case type selection, in accordance with aspects of the present disclosure;

FIG. 11A is a block diagram illustrating selection of a sub-case type selection after performing a selection at higher level selection types within a hierarchy of selection types, in accordance with aspects of the present disclosure; and

FIG. 11B is a block diagram illustrating a quick case type selection, in accordance with aspects of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and enterprise-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As used herein, the term “computing system” refers to an electronic computing device such as, but not limited to, a single computer, virtual machine, virtual container, host, server, laptop, and/or mobile device, or to a plurality of electronic computing devices working together to perform the function described as being performed on or by the computing system. As used herein, the term “medium” refers to one or more non-transitory, computer-readable physical media that together store the contents described as being stored thereon. Embodiments may include non-volatile secondary storage, read-only memory (ROM), and/or random-access memory (RAM). As used herein, the term “application” refers to one or more computing modules, programs, processes, workloads, threads and/or a set of computing instructions executed by a computing system. Example embodiments of an application include software modules, software objects, software instances and/or other types of executable code.

As used herein, the term “agent” refers to an administrative agent (e.g., a support or service agent) and/or to a computer generated intelligent virtual agent. Also, as used herein, the term “category” refers to a general or broad topic for a resolution for a customer request. The category may be the highest level of topics in a hierarchy of multiple topics. As used herein, the term “case” refers to a sub-class of the category. The term “sub-case” refers to a subclass of the case and may be a lowest level or intermediate level of topics within the hierarchy of multiple topics (e.g., two, three, five, ten, and so forth, levels of topics). That is, the sub-case may be the last topic level for identifying the resolution. A workflow process for identifying the resolution for the customer request may include identifying a category, a case, and a sub-case. From a user or agent perspective, the category, the case, and the sub-case may be translated to selectable options on a display interface (e.g., an interface for a portal that receives the customer request), such that the selectable options may be a display option that corresponds to the category, case, or sub-case. In summary, from a workflow perspective, resolving the request involves an identification of the category, the case, and the sub-case and from an agent perspective, resolving the request involves selecting from selectable options corresponding to the category, case, and sub-case on the display interface.

Additionally, as used herein, the term “category type selection” refers to the general or broad topic selection corresponding to the category on the display interface for a resolution for the request. The category type selection may be the highest level of selection type in a hierarchy of multiple selection types corresponding to topics. The term “case type selection,” as used herein, refers to a subclass selection of the category type selection on the display interface. For example, upon a selection of the category case type selection, multiple case type selections may be presented on the display interface. Also, as used herein, the term “sub-case type selection” refers to a subclass selection of the case type selection on the display interface and is a lowest or intermediate level of selection type within the hierarchy of multiple selection types.

Also, as used herein, the term “manual case type selection” refers to a multiple step sub-case type selection on the display interface that includes a manual or user selection step at each level of selection types within the hierarchy of selection types. That is, the manual case type selection includes a selection at the highest level of selection types through the lowest level of selection types. For example, the manual case type selection may involve a selection of the category type selection, a selection of the case type selection presented as a result of the category type selection, and a selection of the sub-case type selection presented as a result of the case type selection, on the display interface. The term “quick case type selection,” as used herein, refers to a selection of the sub-case type selection in fewer steps than utilized for the manual case type selection. For example, the quick case type selection may be a single-step selection. That is, rather than selecting from category type selection options, case type selection options, sub-case type selection options, and so forth, the quick case type selection may include or present a subset of the sub-case type selection options as initial selection options. By way of example, an agent in a business context selecting a sub-case type selection for receiving a resolution to resolve a customer request, may select a sub-case type selection of “replace credit card” in a single selection rather than initially selecting a category of “onboarding,” then selecting a case type of “order case,” and subsequently selecting the sub-case type selection “replace credit card.”

As discussed herein, a customer may send a request to an agent for a resolution to one or more customer or business related issues, interests, or concerns raised by the customer. Often, the customer request may be associated with other requests. That is, one or more requests may be based on a root case. Thus, the agent determining the resolution for the request may subsequently determine a resolution for a related issue associated with the request. By way of example, the agent may navigate through category type selections, case-type selections of a selected category, and sub-case type selections of a selected case type and/or sub-case type, to resolve each of the requests. Thus, after the agent steps through multiple selections on an agent interface (e.g., display interface) to ultimately select the sub-case type selection for the request, the agent may repeat the steps and/or input the same or similar information for the next request when the requests are associated with the same category type selection and/or case type selection. In some instances, the particular agent may be a member of a particular division within the organization or have limited access rights, and as such, may be limited to selecting certain sub-case type selections related to the division or within their access rights when resolving the request, but may still have to step through category type selections, case type selections, and/or sub-case type selections that may ultimately be unavailable for selection by the particular agent.

Accordingly, it is now appreciated that there is a need to efficiently manage and resolve multiple sub-case type selections and associated or related sub-case type selections stemming from the same case type selection, so as to reduce or eliminate the time used to select an initial category type selection and/or case type selection. Efficiently managing and resolving multiple sub-case type selections and associated or related sub-case type selections may also reduce the time to input the same information for the sub-case type selections. Moreover, there is also a need to efficiently provide a selection of the sub-case type selections based on certain conditions, such as relevance for a group within the organization and/or access rights associated with the organization, relevance and/or access rights for an agent identifier (ID) associated with the particular agent, (e.g., agent ID) for the various sub-case type selections, skill level of the particular agent, time of day when resolving the request, and/or level of workload associated with the particular agent. However, determining the sub-case type selections for quick selection (e.g., a single step selection or skipping initial selection of category type selection and/or case type selection) for the particular agent to resolve the request, may be difficult to implement in practice. Moreover, mapping information from a presently selected sub-case type selection to a related sub-case type selection may also be difficult to implement in practice.

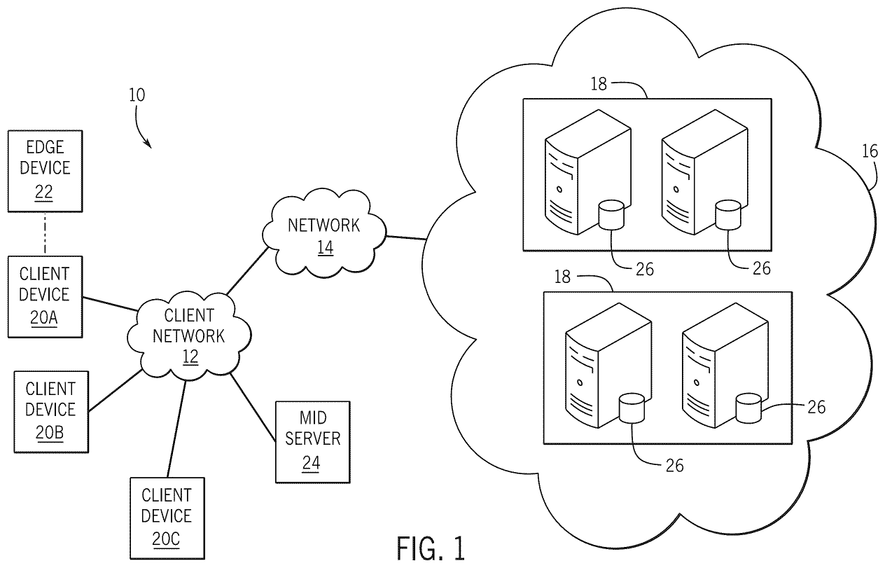

With the preceding in mind, the following figures relate to various types of generalized system architectures or configurations that may be employed to provide services to an organization in a cloud-computing framework and on which the present approaches may be employed. Correspondingly, these system and platform examples may also relate to systems and platforms on which providing simultaneous or streamlined resolutions for customer requests, as discussed herein, may be implemented or otherwise utilized. Turning now to FIG. 1, a schematic diagram of an embodiment of a cloud computing system 10, where embodiments of the present disclosure may operate, is illustrated. The cloud computing system 10 may include a client network 12, a network 14 (e.g., the Internet), and a cloud-based platform 16. In some implementations, the cloud-based platform 16 may be a configuration management database (CMDB) platform. In one embodiment, the client network 12 may be a local private network, such as local area network (LAN) having a variety of network devices that include, but are not limited to, switches, servers, and routers. In another embodiment, the client network 12 represents an enterprise network that may include one or more LANs, virtual networks, data centers 18, and/or other remote networks.

As shown in FIG. 1, the client network 12 is able to connect to one or more client devices 20A, 20B, and 20C so that the client devices 20 are able to communicate with each other and/or with the network hosting the platform 16. The client devices 20 may be computing systems and/or other types of computing devices generally referred to as Internet of Things (IoT) devices that access cloud computing services, for example, via a web browser application, a portal, or via an edge device 22 that may act as a gateway between the client devices 20 and the platform 16. In some implementations, client devices 20 using a portal to access the cloud computing services may be used to send a request to resolve an issue to an agent via the portal. The agent may select a sub-case type selection from a subset of sub-case type selection on a display interface for the portal to resolve the request, as discussed herein.

FIG. 1 also illustrates that the client network 12 includes an administration or managerial device, agent, or server, such as a management, instrumentation, and discovery (MID) server 24 that facilitates communication of data between the network hosting the platform 16, other external applications, data sources, and services, and the client network 12. Although not specifically illustrated in FIG. 1, the client network 12 may also include a connecting network device (e.g., a gateway or router) or a combination of devices that implement a client firewall or intrusion protection system.

As depicted, the client network 12 may be coupled to a network 14. The network 14 may include one or more computing networks, such as other LANs, wide area networks (WAN), the Internet, and/or other remote networks, to transfer data between the client and/or the client's customers and the network hosting the platform 16. For example, the client may send a request to the agent using the client network 12 that connects to the network 14. The agent may resolve one or more sub-cases associated with the request by selecting one or more sub-case type selections on the display interface.

Each of the computing networks or infrastructures discussed herein may contain wired and/or wireless programmable devices that operate in the electrical and/or optical domain. For example, network 14 may include wireless networks, such as cellular networks (e.g., Global System for Mobile Communications (GSM) based cellular network), IEEE 802.11 networks, and/or other suitable radio-based networks. For example, the networks may also employ any number of network communication protocols, such as Transmission Control Protocol (TCP) and Internet Protocol (IP). Although not explicitly shown in FIG. 1, the network and infrastructures shown may include a variety of network devices, such as servers, routers, network switches, and/or other network hardware devices configured to transport data.

In FIG. 1, the network hosting the platform 16 may be a remote network (e.g., a cloud network) that is able to communicate with the client devices 20 via the client network 12 and network 14. The network hosting the platform 16 provides additional computing resources to the client devices 20 and/or the client network 12. For example, by utilizing the network hosting the platform 16, users of the client devices 20 are able to build and execute applications for various enterprises, IT, and/or other organization-related functions. In one embodiment, the network hosting the platform 16 is implemented on the one or more data centers 18, where each data center may correspond to a different geographic location. Each of the data centers 18 includes a plurality of virtual servers 26 (also referred to herein as application nodes, application servers, virtual server instances, application instances, or application server instances), where each virtual server 26 may be implemented on a physical computing system, such as a single electronic computing device (e.g., a single physical hardware server) or across multiple-computing devices (e.g., multiple physical hardware servers). Examples of virtual servers 26 include, but are not limited to a web server (e.g., a unitary Apache installation), an application server (e.g., unitary JAVA Virtual Machine), and/or a database server (e.g., a unitary relational database management system (RDBMS) catalog).

To utilize computing resources within the platform 16, network operators may choose to configure the data centers 18 using a variety of computing infrastructures. In one embodiment, one or more of the data centers 18 are configured using a multi-tenant cloud architecture, such that one of the server 26 instances handles requests from and serves multiple customers. Data centers 18 with multi-tenant cloud architecture commingle and store data from multiple customers, where multiple customer instances are assigned to one of the virtual servers 26.

In a multi-tenant cloud architecture, the particular virtual server 26 distinguishes between and segregates data and other information of the various customers. For example, a multi-tenant cloud architecture may assign a particular customer identifier (ID) for each client (e.g., organization) in order to identify and segregate the data from each client. Generally, implementing a multi-tenant cloud architecture may suffer from various drawbacks, such as a failure of a particular one of the server 26 instances causing outages for all clients allocated to the particular server instance.

In another embodiment, one or more of the data centers 18 are configured using a multi-instance cloud architecture to provide every client its own unique client instance or instances. For example, a multi-instance cloud architecture may provide each client instance with its own dedicated application server and dedicated database server. In other examples, the multi-instance cloud architecture may deploy a single physical or virtual server 26 and/or other combinations of physical and/or virtual servers 26, such as one or more dedicated web servers, one or more dedicated application servers, and one or more database servers, for each client instance.

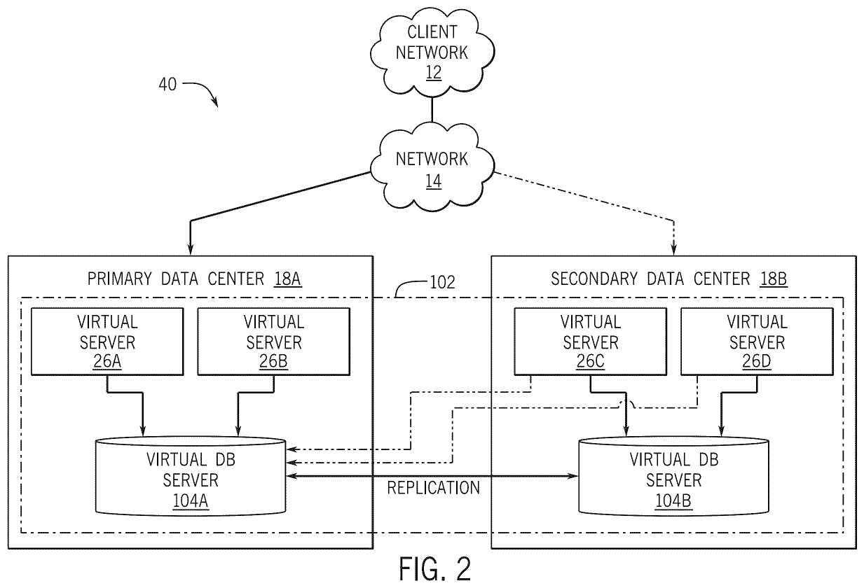

In a multi-instance cloud architecture, multiple client instances may be installed on one or more respective hardware servers, where each client instance is allocated certain portions of the physical server resources, such as computing memory, storage, and processing power. By doing so, each client instance has its own unique software stack that provides the benefit of data isolation, relatively less downtime for clients to access the platform 16, and client-driven upgrade schedules. An example of implementing a client instance within a multi-instance cloud architecture will be discussed in more detail below with reference to FIG. 2.

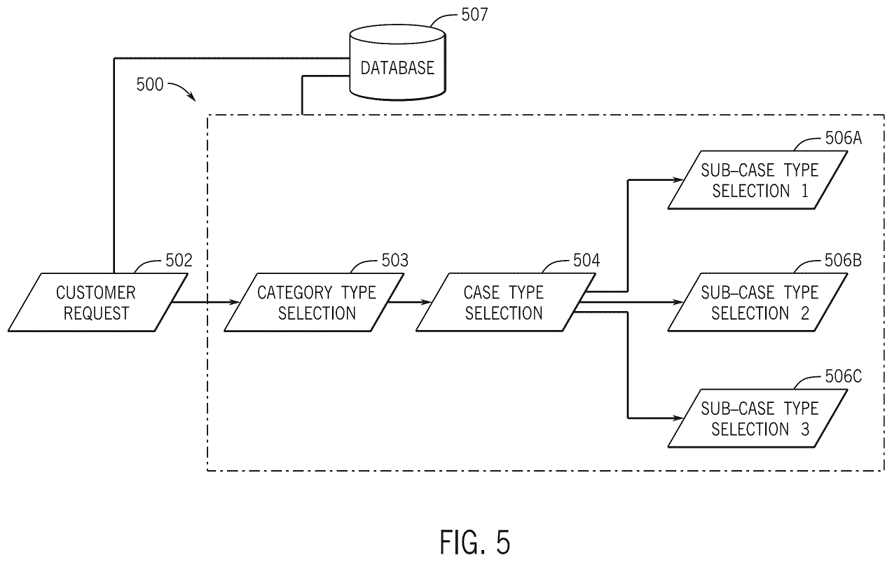

As discussed herein, the client instance may be associated with an organization or business that provides a product and/or business to one or more customers. As part of enhancing customer experience of a computer environment, such as those described above, an agent of the client (e.g., agent) may provide a solution or a resolution to a customer request received in the agent portal (e.g., a client portal to access the that access cloud computing services of FIG. 1) by selecting a sub-case type selection in the display interface for the agent portal and applying the appropriate resolution. The agent (e.g., via a processor of the system) may also receive partial or complete pre-filled information for additional related sub-case type selections using data associated with the presently selected sub-case type selection. As will be discussed with respect to in FIGS. 5-9, field values and other data from one sub-case type selection may be used to truncate selection of related sub-case type selections and determine field values for respective resolutions. For example, and as will be discussed herein, the quick case type selection may be associated with a case base table, which may facilitate automating or filling at least some of the information for generating and resolving related sub-case type selections associated with a presently selected sub-case type selection.

FIG. 2 is a schematic diagram of an embodiment of a multi-instance cloud architecture 40 where embodiments of the present disclosure may operate. FIG. 2 illustrates that the multi-instance cloud architecture 40 includes the client network 12 and the network 14 that connect to two (e.g., paired) data centers 18A and 18B that may be geographically separated from one another. Using FIG. 2 as an example, network environment and service provider cloud infrastructure client instance 102 (also referred to herein as a client instance 102) is associated with (e.g., supported and enabled by) dedicated virtual servers (e.g., virtual servers 26A, 26B, 26C, and 26D) and dedicated database servers (e.g., virtual database servers 104A and 104B). Stated another way, the virtual servers 26A-26D and virtual database servers 104A and 104B are not shared with other client instances and are specific to the respective client instance 102.

In the depicted example, to facilitate availability of the client instance 102, the virtual servers 26A-26D and virtual database servers 104A and 104B are allocated to two different data centers 18A and 18B so that one of the data centers 18 acts as a backup data center. Other embodiments of the multi-instance cloud architecture 40 may include other types of dedicated virtual servers, such as a web server. For example, the client instance 102 may be associated with (e.g., supported and enabled by) the dedicated virtual servers 26A-26D, dedicated virtual database servers 104A and 104B, and additional dedicated virtual web servers (not shown in FIG. 2).

Although FIGS. 1 and 2 illustrate specific embodiments of a cloud computing system 10 and a multi-instance cloud architecture 40, respectively, the disclosure is not limited to the specific embodiments illustrated in FIGS. 1 and 2. For instance, although FIG. 1 illustrates that the platform 16 is implemented using data centers, other embodiments of the platform 16 are not limited to data centers and may utilize other types of remote network infrastructures. Moreover, other embodiments of the present disclosure may combine one or more different virtual servers into a single virtual server or, conversely, perform operations attributed to a single virtual server using multiple virtual servers. For instance, using FIG. 2 as an example, the virtual servers 26A, 26B, 26C, 26D and virtual database servers 104A, 104B may be combined into a single virtual server. Moreover, the present approaches may be implemented in other architectures or configurations, including, but not limited to, multi-tenant architectures, generalized client/server implementations, and/or even on a single physical processor-based device configured to perform some or all of the operations discussed herein. Similarly, though virtual servers or machines may be referenced to facilitate discussion of an implementation, physical servers may instead be employed as appropriate. The use and discussion of FIGS. 1 and 2 are only examples to facilitate ease of description and explanation and are not intended to limit the disclosure to the specific examples illustrated therein.

As may be appreciated, the respective architectures and frameworks discussed with respect to FIGS. 1 and 2 incorporate computing systems of various types (e.g., servers, workstations, client devices, laptops, tablet computers, cellular telephones, and so forth) throughout. For the sake of completeness, a brief, high level overview of components typically found in such systems is provided. As may be appreciated, the present overview is intended to merely provide a high-level, generalized view of components typical in such computing systems and should not be viewed as limiting in terms of components discussed or omitted from discussion.

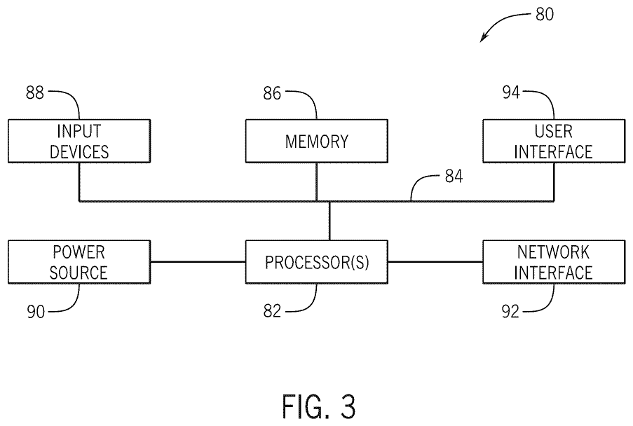

With this in mind, and by way of background, it may be appreciated that the present approach may be implemented using one or more processor-based systems such as shown in FIG. 3. Likewise, applications and/or databases utilized in the present approach may be stored, employed, and/or maintained on such processor-based systems. As may be appreciated, such systems as shown in FIG. 3 may be present in a distributed computing environment, a networked environment, or other multi-computer platform or architecture. Likewise, systems such as that shown in FIG. 3, may be used in supporting or communicating with one or more virtual environments or computational instances on which the present approach may be implemented.

With this in mind, an example computer system may include some or all of the computer components depicted in FIG. 3. FIG. 3 generally illustrates a block diagram of example components of a computing system 80 and their potential interconnections or communication paths, such as along one or more busses. As illustrated, the computing system 80 may include various hardware components such as, but not limited to, one or more processors 82, one or more busses 84, memory 86, input devices 88, a power source 90, a network interface 92, a user interface 94 (e.g., a display interface), and/or other computer components useful in performing the functions described herein.

The one or more processors 82 may include one or more microprocessors capable of performing instructions stored in the memory 86. For example, instructions may include instructions for generating rules for automatically mapping field values or other data for a selected a sub-case type selection to different and/or additional related sub-case type selections based on a case base table. The instructions may also include instructions for providing quick case type selections tailored to a particular agent (e.g., based on an agent identifier (ID) associated with the particular agent). Additionally or alternatively, the one or more processors 82 may include application-specific integrated circuits (ASICs), field-programmable gate arrays (FPGAs), and/or other devices designed to perform some or all of the functions discussed herein without calling instructions from the memory 86.

With respect to other components, the one or more busses 84 include suitable electrical channels to provide data and/or power between the various components of the computing system 80. The memory 86 may include any tangible, non-transitory, and computer-readable storage media. Although shown as a single block in FIG. 1, the memory 86 may be implemented using multiple physical units of the same or different types in one or more physical locations. The input devices 88 correspond to structures to input data and/or commands to the one or more processors 82. For example, the input devices 88 may include a mouse, touchpad, touchscreen, keyboard and the like.

The power source 90 may be any suitable source for power of the various components of the computing system 80, such as line power and/or a battery source. The network interface 92 may include one or more transceivers capable of communicating with other devices over one or more networks (e.g., a communication channel). The network interface 92 may provide a wired network interface or a wireless network interface. A user interface 94 may include a display that is configured to display text or images transferred to it from the one or more processors 82. In addition and/or alternative to the display, the user interface 94 may include other devices for interfacing with a user, such as lights (e.g., LEDs), speakers, and the like.

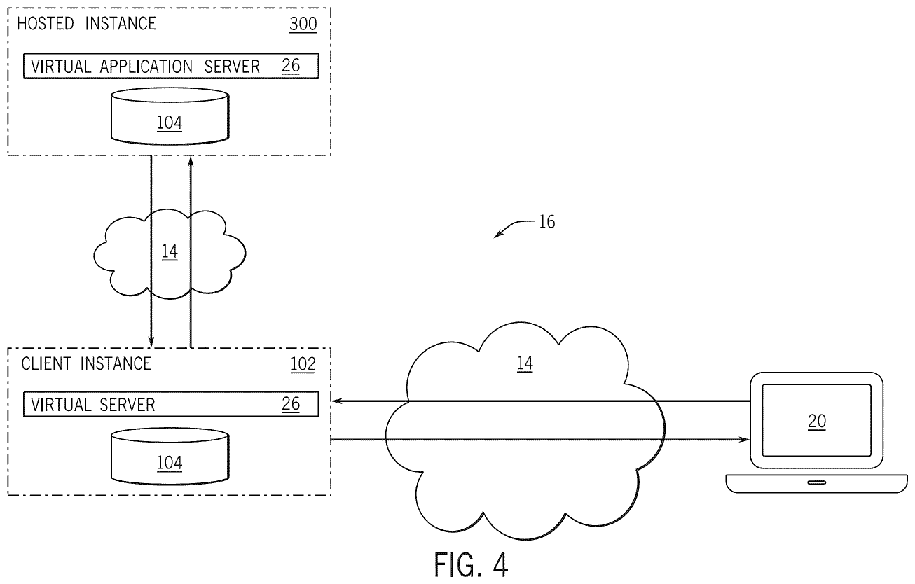

With the preceding in mind, FIG. 4 is a block diagram illustrating an embodiment in which a hosted instance 300 supports and enables the client instance 102, according to one or more disclosed embodiments. More specifically, FIG. 4 illustrates an example of a portion of a service provider cloud infrastructure, including the cloud-based platform 16 discussed above. The cloud-based platform 16 is connected to a client device 20D via the network 14 to provide a user interface to network applications executing within the client instance 102 (e.g., via a client portal on the client device 20D). Client instance 102 is supported by virtual servers 26 similar to those explained with respect to FIG. 2, and is illustrated here to show support for the disclosed functionality described herein within the client instance 102. Cloud provider infrastructures are generally configured to support a plurality of end-user devices, such as client device 20D, concurrently, wherein each end-user device is in communication with the single client instance 102. Also, cloud provider infrastructures may be configured to support any number of client instances, such as client instance 102, concurrently, with each of the instances in communication with one or more end-user devices. As such, single or multiple client instances 102 or the hosted instance 300 may provide a system for efficiently managing one or more requests for a customer by providing a quick case type selection on the display interface of the agent portal, as described herein.

To illustrate, FIG. 5 is a flow diagram for extending information from a case type selection to one or more sub-case type selections, for example, on the display interface for the agent portal. As previously discussed, the selection process on the display interface for the agent corresponds to identifying topics and sub-topics in the workflow to identify the resolution or to assign tasks to be performed as part of resolving a customer issue. As shown, the flow diagram 500 includes a customer request 502 (e.g., a request from a customer of an organization or business) that may be generated in response to a customer contacting an agent of the organization (e.g., customer facing agent). The customer request 502 may include a request for support or service related to the particular customer. In a banking context, the organization may include a bank and the customer may include a person associated with one or more accounts with the bank (e.g., credit card account, debit card account, home loan account, automobile loan account, etc.).

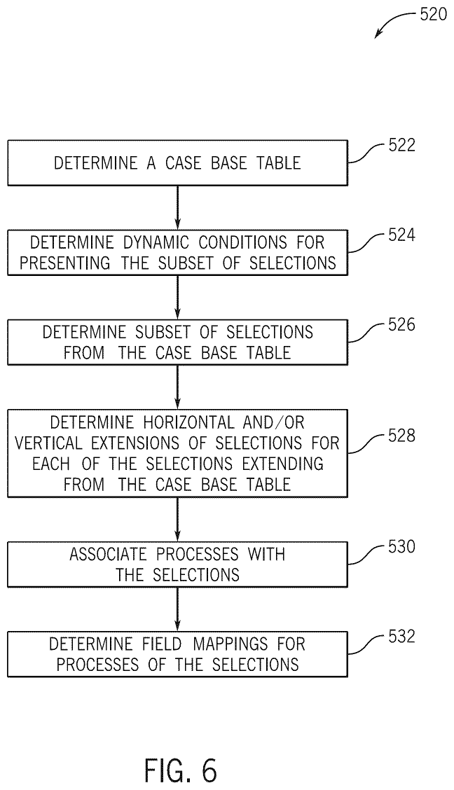

Briefly, and as will be discussed in detail with respect to FIG. 6, an agent may select a category type selection 503 and a case type selection 504 on the display interface based on the customer request 502. The case type selection 504 may be associated with one or more sub-case type selections 506 (e.g., a first sub-case type selection 506A (sub-case type selection 1), a second sub-case type selection 506B (sub-case type selection 2), a third sub-case type selection 506C (sub-case type selection 3), and so forth). That is, resolving the case type selection 504 based on the customer request 502 may involve resolving or completing processes corresponding to the one or more sub-case type selections 506. Each of the sub-case type selections 506 may be assigned to respective groups within the organization that perform respective processes to resolve the particular sub-case type selections 506.

In some embodiments, the possible category type selections 503, case type selections 504, and/or the sub-case type selections 506 may be stored in a database 507. The database 507 may also store one or more case base tables that indicate the horizontal and/or vertical relationships between category type selections 503, case type selections 504, and/or the sub-case type selections 506 to address the customer request 502. Moreover, the database 507 may store customer information along with a customer identification (ID), for example, associated with the pending customer request 502. In some embodiments, the database 507 may store a log or history of past or pending customer requests 502, resolutions provided for the customer requests 502, customer activity with the organization (e.g., communication between the customer and the agent), customer preferences, customer ID, and/or any other information that may provide insight into the customer's relationship with the organization and customer requests 502. In some embodiments, the customer information may provide an indication of the most relevant sub-case type selection 506 for the agent to address the pending customer request 502. The database 507 may also store information related to the particular agent, such as but not limited to, access rights for sub-case type selections 506, skill level, work load bandwidth or capacity for resolving customer requests 502, organization group associated with the agent, and other information that may be utilized when providing a subset of sub-case type selections 506 for the particular agent.

Continuing with the banking context, the case type selection 504 may include a request to resolve an issue of a lost credit card, which may be resolved by at least one sub-case type selection 506. The selected sub-case type selection 506 may be associated with additional related sub-case type selections 506 stemming from the case type selection 504 of the lost credit card, such as the sub-case type selections 506 of closing the credit card account number, deactivating the credit card, opening a new credit card account number to replace the closed credit card account number, and/or issuing a new credit card. Different groups of the organization may perform different steps to complete these processes associated with the sub-case type selections 506 to ultimately resolve the customer request 502. Specifically, middle office agents within the groups that do not have direct interactions with the customer may work on specific tasks and perform processes associated with the resolutions for the sub-case type selections. As will be described herein, linking and/or automatically filling in information for one or more related sub-case type selections 506 associated with a presently selected sub-case type selection 506 may facilitate efficiently resolving one or more customer requests 502. In some embodiments, the front office agent that is customer facing may resolve the request with quick case selecting the sub-case type selection 506, such that the front office agent performs the processes associated with the resolution rather than sending information for further processing by the middle office agent.

Moreover, providing a quick case selection of the sub-case type selections 506 and dynamically updating conditions for presenting options of sub-case type selections 506, may also facilitate efficiently resolving the one or more customer requests 502. Briefly, and as will be discussed in detail with respect to FIG. 6, conditions associated with generating a subset of sub-case type selections 506 for the particular agent may be updated, removed, and otherwise modified. These modifications correspondingly update the subset of sub-case type selections 506 presented to the agent on the display interface. Although the following descriptions describe linking sub-case type selections 506, generating quick case type selections for sub-case type selections 506, and/or updating conditions for quickly selecting the sub-case type selections, which represents a particular embodiment, the systems and methods described herein may additionally or alternatively apply to category type selections 503 and/or case type selections 504. Additionally, although the following descriptions describe information as field values, such as a string of characters or numbers for fields related to the selection, which represents a particular embodiment, the systems and methods described herein may apply to other information. For example, other information may include, but is not limited to, data related to the customer agent, the organization, and/or the organization goals or priorities, and data related to the customer and/or similarly situated customers (e.g., same range of salary, address in the same state, etc.).

To illustrate the process for generating selections for sub-case type selections 506, FIG. 6 depicts a process 520 for generating field mappings for sub-case types for the sub-case type selections 506. The process 520 for generating selectable options on the display interface to receive the resolution to the customer request corresponds to a determination or identification of a category, case, and sub-case in the workflow process for identifying the resolution. As described herein, the process 520 describes generating the sub-case type selections 506 for agent selection on the display interface of the agent portal, and providing additional or related sub-case type selections 506 (e.g., not selected by agent) upon the selection of an initial sub-case type selection 506 based on a common case type selection 504. That is, the workflow process involves identifying a case and automatically identifying related sub-cases. The subset of sub-case type selections 506 (e.g., selectable display options) may be narrowly tailored for the particular agent and/or group associated with the agent. In this manner, the agent may avoid unnecessarily navigating through a list of sub-case type selections 506 that the agent may not have access or authority to select.

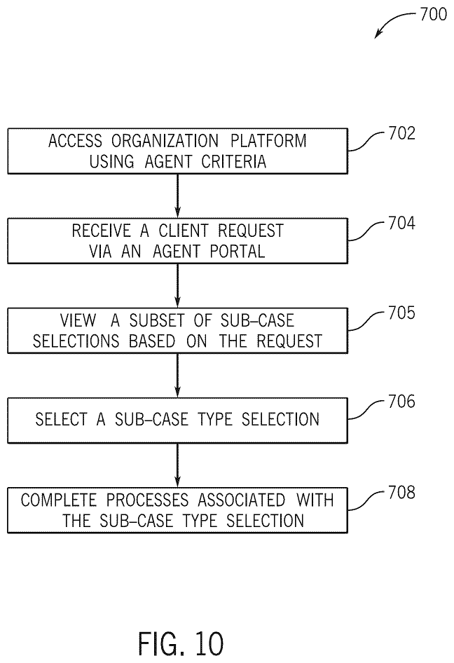

While the process 520, and other processes described herein (e.g., process 700 of FIG. 10) is described according to a certain sequence, it should be understood that the present disclosure contemplates that the described steps may be performed in different sequences than the sequence illustrated or in parallel to one another, and certain described steps may be skipped or not performed altogether. In some embodiments, the process 520 may be implemented at least in part by executing instructions stored in a tangible, non-transitory, computer-readable medium, such as the memory 86, using processing circuitry, such as the processor 82. Additionally or alternatively, the process 520 may be implemented at least in part by circuit connections and/or control logic implemented in a cloud computing system 80. In some implementations, the process 520 may be implemented by the server 26 of FIG. 2, which may be associated with an underlying hardware implementation that includes a memory 86 and processor 82.

To generate the narrowly tailored subset of sub-case type selections 506 for agent selection, the process 520 may include the processor 82 determining (block 522) a case base table. The case base table may be stored in the database 507 or any suitable memory structure. In some embodiments, the case base table may include each defined customer request 502 (e.g., an issue, problem, activity, etc.), category type selection 503, case type selection 504, and sub-case type selection 506. That is, for a category type selection 503, the case base table may link available or defined related case type selections 504, and for each case type selection 504, the case base table may link each related sub-case type selection 506. Thus, a case type selection 504 may be an extension of the case base table. The links may be based on relevance or a relationship between case type selections 504, sub-case type selections 506, and/or case type selections 504 and sub-case type selections 506. For example, for a particular case type selection 504, the agent may typically resolve multiple relevant sub-case type selections 506. Thus, for a sub-case type selection 506, the case base table may indicate a linkage to the other relevant sub-case type selections 506 based at least on the common case type selection 504 and/or common category type selection 503. In other embodiments, each customer request 502 may be associated with a case base table, such that the database 507 stores multiple case base tables, each corresponding to a different issue, problem, activity, and so forth.

The process 520 may include the processor 82 determining (block 524) dynamic conditions for the particular agent to receive requests and/or access to selections. The conditions may include, but are not limited to, relevance for a group within the organization and/or access rights associated with the organization, group of agents authorized to select various sub-case type selections 506, relevance and/or access rights for the agent ID for the sub-case type selections 506, skill level of the particular agent, time of day when resolving the request, and/or level of workload associated with the particular agent. An administrator may define objects and fields for creating the conditions, associating one or more of the conditions for each of the sub-case type selections 506, and evaluation of the one or more conditions. The evaluation may involve using logical operators, such as OR and/or AND. By way of example, if any one condition of multiple conditions are true in an OR evaluation for the agent and sub-case type selection 506, then the sub-case type selection 506 may be enabled for selection. In some embodiments, the processor 82 may dynamically modify the conditions, such as by updating, changing, and/or removing the conditions and/or the objects and fields. For example, conditions may be modified according to changes in processes for resolutions and/or the skill level for the agent. Additionally or alternatively, the conditions may be modified based on machine learning and/or scheduling as set by the administrator.

By way of example, the agent may belong to a group that resolves tasks associated with a particular service or product corresponding to a subset of case types (e.g., case type selections 504 and/or sub-case type selections 506). As such, agents of the group may not have access to sub-case type selections 506 for a different, unrelated group. Thus, upon receiving the customer request 502, the processor 82 may limit the quick sub-case type selections 506 to those enabled for access by the particular agent. As will be discussed in detail with respect to FIG. 10, the dynamic conditions for generating quick select sub-case type selections 506 may be based on a change in skill level or certifications for the agent.

The process 520 may include the processor determining (block 526) the subset of sub-case type selections 506 from the case base table based on the customer request 502 and the conditions. That is, the processor 82 may determine the options of category type selections 503, case type selections 504, and/or sub-case type selections 506 that may be presented to the agent on the display interface for the particular request. Based on the possible resolutions for resolving the particular customer request 502 and the conditions previously discussed (e.g., agent access rights to select particular sub-case type selections), the processor 82 may determine relevant category type selections 503, relevant case type selections 504, and/or sub-case type selections 506. Narrowly tailoring the options to the subset may allow the agent to efficiently navigate through and select the relevant sub-case type selection 506. Thus, the agent may avoid navigating through each possible selection associated with each customer request 502 in the system.

Additionally or alternatively to the conditions, the process 520 may utilize customer information for generating or filtering the selections for the subset. For example, based on a history of previous customer requests 502 associated with the customer ID for the particular customer (e.g., stored in the database 507), the processor 82 may determine the relevant sub-case type selections 506. By way of example, the customer may have recently received a replacement card for a particular bank account, and thus, based on the history indicating issuance of a replacement card, the processor may determine that the customer is requesting a resolution for a task related to the replacement card (e.g., activating the replacement card, replacing a damaged replacement card, failed to receive replacement card by expected delivery date, etc.). Thus, the processor 82 may present the most appropriate sub-case type selections 506 on the display interface so that the agent may quickly select the sub-case type selection (e.g., single step, quick case type selection). In some embodiments, the processor 82 may generate a single sub-case type selection 506 based on the conditions associated with the sub-case type selection for the agent and the customer information.

The process 520 may include the processor 82 determining (block 528) a horizontal and/or vertical extension of selections for each of the selection types (e.g., case type selections 504 and/or sub-case type selections 506) extending from the case base table. As previously mentioned, the case base table may link related category type selections 503, case type selections 504, and/or sub-case type selections 506. The linkage may be vertical (e.g., downstream from the category type selection 503, to the various case type selections 504, and/or to the sub-case type selections 506) and/or horizontal (e.g., between the category type selections 503, the case type selections 504, and/or the sub-case type selections 506).

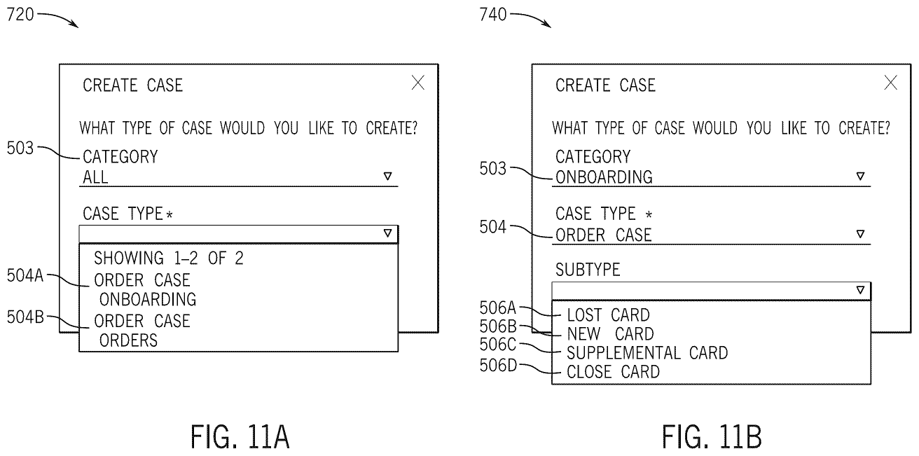

By way of example, and as will be discussed in detail with respect to FIG. 11B, if a customer requests help with a lost credit card, the agent may determine that the customer request 502 is associated with a category type selection 503 of “onboarding” and from this category, the agent may select a case type selection 504 of “order case” to place an order for a card, and from this case type selection 504 the agent may select a sub-case type selection 506 of “lost card.” The case base table may link a case type selection 504 of “order case” to another case type selection 504, such as a case type selection 504 of “fraud case,” providing a horizontal linkage. In another example, the case base table may link case type selection 504 of “order case” to sub-case type selections 506 “new card,” “supplemental card,” “close card,” and so forth, providing a vertical linkage. In some embodiment, the case base table may link one or more case type selections 504 and one or more sub-case type selections 506 (e.g., both horizontal and vertical links). That is, upon a selection of a particular sub-case type selection 506, the processor 82 may automatically trigger and fulfill processes associated with related sub-case type selections 506 based on the case base table.

In summary, the case base table links category type selections 503, case type selections 504, and/or sub-case type selections 506 that may be related to one another for resolving one or more customer requests 502. By way of example, a group assigned to resolve a particular sub-case type selection 506 for a customer request 502 by performing processes for the resolution associated with the selected sub-case type selection 506 may also perform additional processes associated with other sub-case type selections 506 as part of a routine to completely resolve the customer request 502. Thus, the case base table may extend a case type selection 504 to one or more case type selections 504 and/or to one or more sub-case type selections 506, and a sub-case type selection 506 to one or more sub-case type selections 506. The related category type selections 503, the case type selections 504, and/or the sub-case type selections 506 may be associated with pending requests and/or facilitate generating new requests for the related sub-case type selections 506. Each of the sub-case type selections 506 may be associated with respective resolution with respective processes. In some instances, other groups may often resolve the related sub-case type selections 506. Thus, the group assigned to resolve the selected sub-case type selection 506 and/or other groups assigned to resolve related sub-case type selections 506 may benefit from partial or complete automatically generated population of field values for the related sub-case type selections 506 (e.g., not selected by agent but linked in case base table) based on information gathered for the selected sub-case type selection 506.

The processor 82 may associate (block 530) processes with each of the sub- case type selections 506, for example, based on the horizontal and/or vertical extensions in the case base table. The processes may correspond to tasks associated with the customer request 502 or the resolutions, and may vary between groups assigned to fulfill the customer requests 502 and/or complete the resolutions. Since a selected sub-case type selection 506 may be related to additional sub-case type selections 506 based at least on a common case type selection 504 in the case base table, the respective processes associated with each of the resolutions for the sub-case type selections 506 may also be related. That is, at least some of the information provided for a selected sub-case type selection 506 may also be pertinent to related sub-case type selections 506 (e.g., not selected by agent but related and linked in case base table). Additionally, general information related to the customer ID, the agent, and/or other information associated with the common case type selection 504 may be pertinent for each sub-case type selection 506 branching from the case type selection 504 in the case base table.

Accordingly, the processor 82 may determine (block 532) field mappings for the processes of the selections. Specifically, the processor 82 may determine that at least one or more of the fields involved in the processes for a particular sub-case type selection 506 is the same or approximately the same as (e.g., corresponds to) one or more fields of processes of the related sub-case type selections 506. The processor 82 may determine similar or different fields for each of the possible sub-case type selections 506. As such, the customer and agent may benefit from automatically populating these fields with the same information. In this manner, the agent may avoid manually entering redundant information in the same one or more fields for the different processes and/or errors may be reduced where different information is erroneously entered for related cases. Moreover, automatically populating some or all of the information for related sub-case type selections 506 may concurrently resolve multiple customer requests 502 associated with each of the related sub-case type selections 506. That is, the customer may have pending customer requests 502 that are related to the presently selected customer request 502, and as such, the agent may resolve the corresponding related sub-case type selections 506 while resolving the selected sub-case type selection 506 for the customer request 502.

The conditions for mapping the fields for the various related sub-case type selections 506 under the same case type selection 504 and category type selection 503 may be dynamically updated. Organizations or groups within the organization may update or modify processes associated with the category type selections 503, the case type selections 504, and/or the sub-case type selections 506. Based on these changes, the processor 82 may correspondingly update the mappings (e.g., remap field mappings). For example, processes previously unrelated or unlinked in the case base table may become related and linked, and vice versa. Thus, at least some of the information for the fields associated with updated and related processes for the sub-case type selections 506 may include the same or approximately the same information.

Based on the field mappings (e.g., original or updated), information input in fields for a selected sub-case type selection 506 may be mapped to fields of related sub-case type selections 506. By way of example, sub-case type selections 506 of “deactivate credit card” and “replace credit card” are both subclasses for the case type selection 504 of “lost credit card,” and thus, some of the field entries may include the same information. The information may include the customer ID, customer personal information (e.g., physical and email addresses), account information to be deactivated, approximate date card was misplaced, and so forth. As such, the processor may map field values between these sub-case type selections 506 for the information.

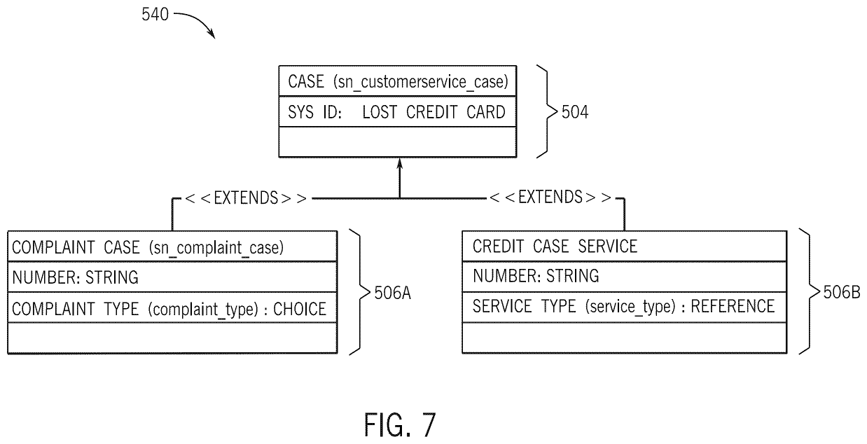

FIG. 7 is a flow diagram of a case base table 540 extending information from a case type selection 504 to sub-case type selections 506. As shown, the case base table 540 includes a “lost credit card” case type selection 504. The “lost credit card” case type selection 504 is vertically linked to a “complaint case” first sub-case type selection 506A and a “credit card service” second sub-case type selection 506B. In general, an administrative agent or administrator may map sub-case type selections 506 to a single case type selection 504. For example, the “lost credit card” case type selection 504 may be associated with business loses for the organization, fraud transactions, replacement cards, and so forth, each corresponding to respective sub-case type selections 506 linked to the “lost credit card” case type selection 504. An administrator may set mapping conditions for field entries or values (e.g., string of characters and/or numbers) from fields of a selected sub-case type selection 506 to fields of the related sub-case type selections 506 since they share a common case type selection 504, indicating that they have at least some of the same information for respective fields. This way, the agent does not have to re-enter the same information or approximately the same information into the same or related fields for the related sub-case type selections 506. That is, metadata from the selected sub-case type selection 506 is mapped to the related sub-case type selections 506. In some instances, the related sub-case type selections 506 may be unavailable to the agent and/or running in the background for the selected sub-case type selection 506. Additionally, when resolving a request and selecting the sub-case type selections 506 on the display interface, the processor 82 may not notify the agent of the automatic implementations of selecting the related sub-case type selection 506 and the field mappings.

Thus, the information automatically or manually entered for the “complaint case” first sub-case type selection 506A may be mapped to corresponding fields for the “credit card service” second sub-case type selection 506B. By way of example, this information may include the customer name, a title “lost credit card” for the case, address for the customer, etc. In some instances, the “complaint case” first sub-case type selection 506A and the “credit card service” second sub-case type selection 506B may be managed by different groups within the organization and thus, may perform different processes or steps to resolve the respective sub-case type selection 506. By automatically populating or prefilling field values for the “credit card service” second sub-case type selection 506B with the metadata of the “complaint case” first sub-case type selection 506A, the group may streamline the processes or perform less steps than would be utilized in a manual entry process (e.g., reentering the same information or similar information for the field values).

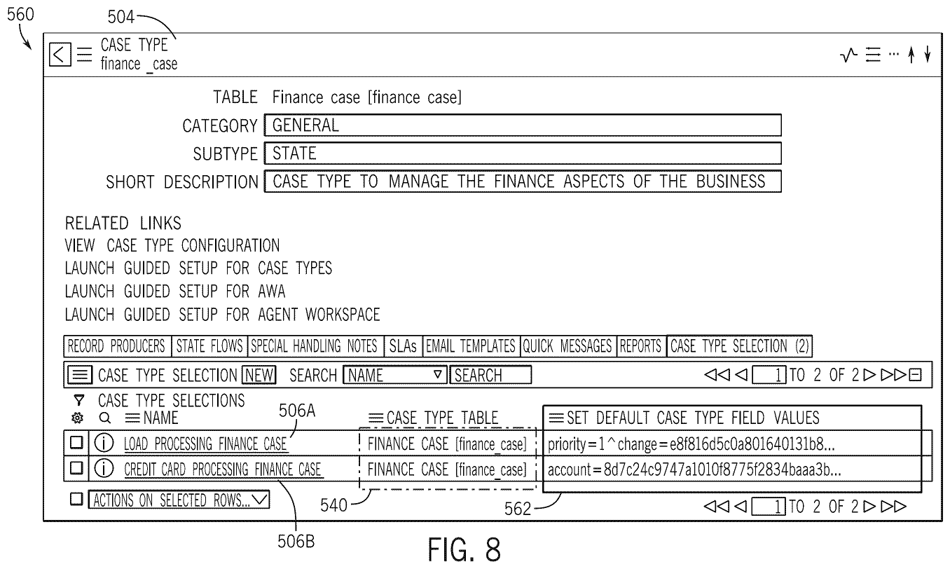

FIG. 8 is a block diagram of a graphical user interface (GUI) 560 in an administrative view for the administrator, depicting an association of a case type selection 504 to sub-case type selections 506 of the case base table 540 of FIG. 7. The administrator may generate, update, and/or modify case base tables 540 in the administrative view of a portal (e.g., accessed using administrative credentials) on the GUI 560. Specifically, the administrator may define logic for implementing the mappings of a case base table 540. Here, the administrative agent is viewing parameters for a record for a “finance_case” case type selection 504. The record includes the “finance_case” case base table 540 associated with a “general” category type selection 503, a “state” sub-case type selection 506, and a description of “case type to manage the finance aspects of business.”

The administrator may link or associate one or more sub-case type selections 506 for the “finance_case” case type selection 504. In the depicted embodiment, the administrative agent links a “loan_processing_finance_case” first sub-case type selection 506A with the “finance_case” case type selection 504 that may be associated with loan processing procedures assigned to a loan processing group. The administrative agent also links a “cred_card_processing_finance_case” second sub-case type selection 506B with the “finance_case” case type selection 504 that may be associated with credit card processing procedures assigned to a credit card processing group. As indicated by the dashed line box, both the sub-case type selections 506 are associated with the same case base table 540 for the same “finance_case” case type selection 504.

As indicated by the solid line box, the administrator may also set field values 562 (e.g., logic parameters) for each of the sub-case type selections 506. That is, the administrative agent may set the number of sub-case type selections 506 corresponding to the case type selection 504, field mappings to related case type selections 504 and/or the sub-case type selections 506, and so forth, upon selection of the case type selection 504 and/or the sub-case type selection 506. Specifically, an administrative agent may define logic to extend predefined fields and/or field values 562 from a case base table 540 to the case type selection 504 and/or sub-case type selections 506. By setting the field values, the attributes defined as the field values for the case type selection 504 may automatically extend and populate the same field values for fields of the sub-case type selections 506 extending from the case type selection 504.

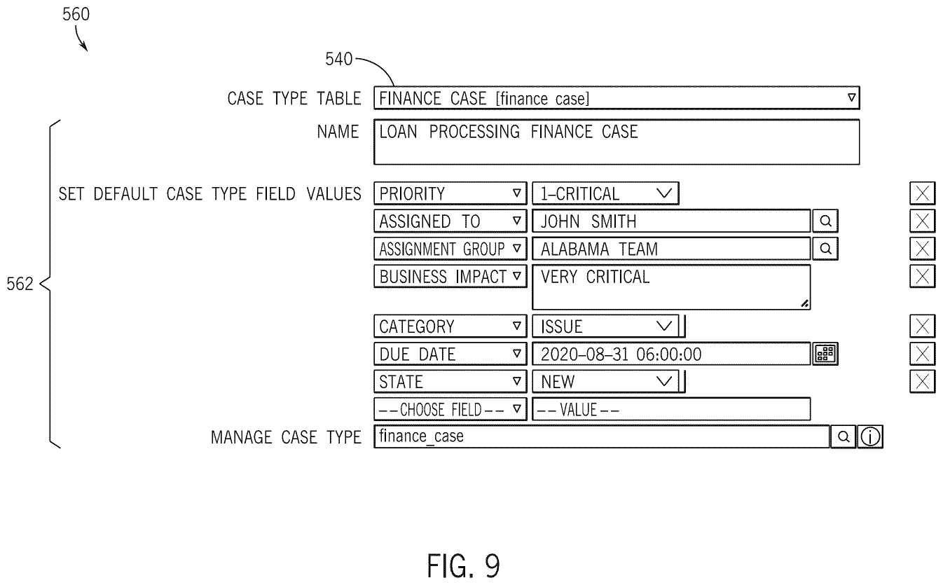

To illustrate, FIG. 9 is a block diagram of the GUI 560 for setting field values 562 for the case type selection 504 of the case base table 540 of FIG. 8. In particular, the administrator may set one or more fields and/or field values 562 for the fields to resolve a selected case type selection 504 and/or a sub-case type selection 506. That is, the administrator may select different fields and enter corresponding field values 562 (e.g., string of characters and/or numbers) to associate with the case type selection 504 and/or sub-case type selection upon agent selection. The administrative agent may update (e.g., add or remove) the fields to associate the case type selections 504 and/or the sub-case type selections 506, and may also update the corresponding field values 562.

By way of example, upon a modification or update of the depicted “finance case” case base table 540, the fields and field values 562 for associated sub-case type selections 506 may automatically populate and correspondingly update. In the depicted embodiment, the administrator sets the field values 562 of a priority level (e.g., 1-critical (depicted), 2-moderate, 3-low, etc.), assigned to one or more particular agents, assigned to an assignment group, impact level the case type selection 504 may have on the organization (e.g., business impact), category type selection 503, due date, and/or state (e.g., new or existing). The administrative agent may continue to add or remove as fields (e.g., “choose field”) to associate with the sub-case type selection 506. In the current embodiment, the administrative agent sets the field value of priority level to “1-critical”, assigned to “John Smith,” assignment group to “Alabama Team,” business impact to “very critical,” category type selection 503 to “issue,” due date to “2020-08-31 06:00:00,” state to “new,” and manage case type to “finance_case.”

Thus, upon a selection of “finance_case” case type selection 504 or a sub-case type selection 506 stemming from the “finance_case” case type selection 504, the processor 82 may automatically generate a resolution or guidance with these fields and values (e.g., tasks and/or associated processes having a critical priority, assigned to John Smith on the Alabama team, having a very critical impact on the business, categorized as an issue, due on Aug. 31, 2020 at 6 AM, and having a new state). In this manner, a processor 82 may automatically apply the applicable field values 562 for a selected sub-case type selection 506 by mapping field values 562 from a parent case type selection 504 from which it extends when a customer agent selects the sub-case type selection 506. As such, the field mappings from the case type selection 504 to the sub-case type selections 506 may facilitate a quick resolution for a customer request 502 without the agent having to re-enter information for the case type selection 504 and/or performing additional button clicks, and so forth.

FIG. 10 is a process 700 for resolving one or more customer requests 502 based on information extended from a case type selection 504. As shown, the process 700 may include a customer agent (e.g., front office agent interfacing with the customer) accessing (block 702) an organization agent portal using agent criteria. That is, the agent may access the portal using agent credentials, such as an agent ID and password. The agent credentials may be associated with access limitations, such that the agent may be restricted to resolving particular customer requests 502 and/or able to select particular sub-case type selections 506 (e.g., based on present skill set).

After accessing the portal, the agent may receive (block 704) a customer request 502 from a customer via the portal. The customer request 502 may be associated with a complaint, an issue, a problem, and so forth, for which the customer agent may receive a guidance to perform one or more steps or processes, to resolve the customer request 502.

Based on the customer request 502 (e.g., with associated customer information) and conditions associated with the particular agent ID and sub-case type selections 506, the agent may view (block 705) a subset of sub-case type selections 506. That is, the agent my receive options of sub-cases to select on the display interface rather than making selections for higher level topics to ultimately view the sub-case type selections. In some embodiments, and as previously mentioned, the agent my receive options of sub-cases based on a customer identification (ID) for the customer (e.g., a customer of the organization). That is, the processor 82 may associate the sub-case type selections 506 with the customer ID to generate the subset of sub-case type selections 506. The processor 82 may link a presently selected sub-case type selection 506 and/or additional sub-case type selections 506 (e.g., not selected but relevant and associated in a case base table 540) with the customer ID. Associating multiple sub-case type selections 506 to the customer ID may facilitate a quick identification of pending requests, previous requests and corresponding resolutions for sub-case type selections 506, and so forth, associated with the customer by a search for requests and/or resolutions with the customer ID. Moreover, the customer ID may indicate a pattern associated with the customer (e.g., the customer associated with the customer ID often loses bank cards and typically requests a replacement card), and that may facilitate generating and/or automatically resolving additional sub-case type selections 506.

To receive the resolution guidance, the customer agent may select (block 706) a sub-case type selection 506 from the subset on the display interface. In some embodiments, the agent may select a category type selection 503, a case type selection 504, and then a sub-case type selection 506 (e.g., manual selection of the sub-case type selection 506). In other embodiments, the processor 82 may provide a quick case type selector, such that the customer agent may select the sub-case type selection 506 in a single selection or in fewer steps than the manual selection (e.g., skip selection of the category type selection 503 and/or the case type selection 504). Thus, the semi-automated selection of the sub-case type selection may quickly resolve the customer request 502. As previously discussed, upon the selection of the sub-case type selection 506, whether via a manual or quick case type selection, the field values 562 for the processes may be automatically populated based on the case base table 540, such that information for the case type selection 504 of the case base table 540 automatically extends for the selected sub-case type selection 506 to the related sub-case type selections 506.

After the sub-case type selection 506, the agent may complete (block 708) the processes associated with the selected sub-case type selection 506 to resolve the customer request 502. Specifically, the agent may be the customer facing agent communicating with the customer by using the portal to address the customer request. In some embodiments, the agent may assign the task to another agent (e.g., middle office agent of a particular group) that completes the processes.

FIG. 11A is a block diagram of a multiple step sub-case type selection 720, in which the agent may select the sub-case type selection 506 after performing a selection at each of the higher level selection types within a hierarchy of selection types (e.g., the category type selection 503 and case type selection 504). As shown, an agent may first select a category type selection 503 from a drop down menu in the agent portal. Based on the category type selection 503, one or more case type selections 504 may be presented in a corresponding drop down menu. In the depicted embodiment, the agent selects “all” category type selection 503 to view all case type selections 504 (e.g., rather than narrowing the options for the case type selections 504 by selecting a particular topic for the category type selection 503). Here, the drop down menu for the case type selections 506 includes an “order case” first case type selection 504A, which is associated with an “onboarding” category type selection 503. The drop down menu also includes an “order case” second case type selection 504B, which is associated with an “orders” category type selection 503. Upon selecting either of the case type selections 506, the processor 82 may present a sub-set of case type selections 506 for selection and/or the agent may manually input the sub-case type selection 506.

However, using the systems and methods described herein, the processor 82 may present the subset of sub-case type selections 506 to the agent on the display interface for quick select, or in a single step (e.g., skipping selection of the category type selection 503). To illustrate, FIG. 11B illustrates the quick case type selection 740. In the depicted embodiment, the agent selects the “order case” first case type selection 504A, which results in a subset of sub-case type selections 506. As shown, the sub-case type selections 506 include a “lost card” first sub-case type selection 506A, a “new card” second sub-case type selection 506B, a “supplemental card” third sub-case type selection 506C, and a “close card” fourth sub-case type selection 506D.

As previously discussed, based on the selection of one of the sub-case type selections 506 to determine a resolution for the customer request 502, the other sub-case type selections 506 in the subset for the common case type selection 504 may be related sub-case type selections 506, such that information (e.g., metadata for field values 562) from the selected sub-case type selection 506 automatically generates requests for the other sub-case type selections 506 to be executed in a particular order or concurrently. By way of example, the related sub-case type selections 506 include the other sub-case type selections 506 presented in the subset. However, as previously discussed, based on the he vertical and/or horizontal relationships of the selections in the case base table 540, additional sub-case type selections 506 may be related sub-case type selections 506. The information from the selected sub-case type selection 506, such as the field values 562, may also automatically populate for the processes for the other sub-case type selections in the subset of the sub-case type selections 506. Moreover, and as previously discussed, field values 562 from the common case type selection 504 (e.g., “order case” case type selection 504) may also automatically populate for the selected sub-case type selection 506 and the related sub-case type selections 506. Thus, the field mappings of the field values 562 may be vertically and/or horizontally mapped.

As previously mentioned, the administrator may set a workflow of selections presented to the agent resolving the customer request 502 on the display interface. Specifically, the administrator may define logic that presents (e.g., displays) manual or quick select options for the sub-case type selections 506 (e.g., the subset of sub-selections 506). As previously discussed, the quick select options may be based on one or more conditions, such as agent credentials indicating authorization to resolve certain customer requests 502. Moreover, the conditions or logic may be reconfigurable, such that the conditions for the quick select may be updated, modified, removed, and so forth.

Dynamically updating the logic for the quick selector may be beneficial as the agent develops different skills over time. By way of example, an agent may be authorized to resolve three cases a day and thus, after resolving three cases, the agent may no longer have access to select a sub-case type selection 506 to resolve a fourth customer request 502. However, after a predetermined time, the administrative agent may update the quick select conditions to allow the customer agent to resolve more than three customer requests. Similarly, as the customer agent acquires new skills in various areas or joins multiple teams, the administrator may update the quick select conditions to allow the agent to resolve multiple different types of customer requests 502, such that more options may be available in the sub-case type selections 506 for the agent.

In some instances, and as previously mentioned, the dynamic conditions for the quick selector may be based on machine learning. The processor 82 may use machine learning to determine and make changes for the customer agent as the customer agent acquires experience or certifications, and is eligible to work on more matters. By way of example, the machine learning may consider particular metrics for a sample size and similarly situated agents, and determine changing conditions to authorize the agent to have access to certain sub-case type selections 506 and update the workflow accordingly. Dynamically updating conditions for the quick selections, such as based on machine learning, may benefit both the organization and the customer agent. The organization may benefit from retaining present employees to perform the additional processes for the sub-case type selections, automatically update conditions using machine learning to efficiently update an agent selection process, and so forth. The agent may benefit from the dynamic updates by having additional tasks to perform based on the new skill set. Machine learning may also provide a recommendation for a selection, such as case type selection 504. In particular, machine learning may predict the case type selection 504 based at least on one or more letters input into a case type selection dialog box on the display interface of the agent portal. By way of example, as an agent inputs “car” into the dialog box, the processor 82 may present case type selections 504 for “card.”

Enabling a quick case type selection for the case type selections 504 and/or the sub-case type selections 506 may allow the agent to take fewer steps to ultimately select the sub-case type selection 506 than the number of steps taken to first select a category type selection 503, which may be associated with a lengthy list of categories that are irrelevant to the agent and the customer request 502. In some embodiments, the quick case type selection may enable selection of a sub-case type selection 506 (and automatic selection of related sub-case type selections 506 for the common case type selection 504) in a single step. Moreover, in some embodiments, mapping field values 562 using a case base table 540 that indicates relationships between the category type selection 503, case type selections 504, and the sub-case type selections, may facilitate efficiently managing one or more requests 502 with related sub-case type selections 506 by automatically populating common information.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A system comprising a platform configured to host one or more client instances, the one or more client instances comprising:
an agent portal configured to:
receive a request from a client device, wherein the request is associated with a category type, and wherein the request is assigned to an agent;
obtain information regarding access rights of the agent;
determine based on the category type and the access rights, a plurality of sub-case types associated with the request; and
initiate resolution of the request based on a selected sub-case type of the plurality of sub-case types.

2. The system of claim 1, wherein the agent corresponds to a virtual agent, wherein the virtual agent is configured to:
select the selected sub-case type; and
initiate the resolution of the request.

3. The system of claim 1, wherein the agent portal is configured to:
obtain customer information associated with the client device, wherein the customer information is indicative of one or more previous interactions with the agent portal; and
determine the plurality of sub-case types associated with the request based at least in part on the customer information and the access rights.

4. The system of claim 1, wherein the agent portal comprises a graphical user interface (GUI), and wherein the agent selects the selected sub-case type via the GUI.

5. The system of claim 4, wherein the GUI is configured to display the category type.

6. The system of claim 4, wherein the selected sub-case type is associated with one or more related sub-case types, wherein the agent portal is configured to update the GUI to display the one or more related sub-case types based on the selected sub-case type.

7. The system of claim 1, wherein the agent portal comprises a graphical user interface (GUI) configured to display the plurality of sub-case types associated with the request for selection.

8. The system of claim 1, wherein the agent portal is configured to initiate the resolution of the request by initiating one or more processes to retrieve additional information associated with the request.

9. The system of claim 8, wherein the selected sub-case type is associated with one or more related sub-case types, and wherein the agent portal is configured to:
generate, in response to receiving the selected sub-case type, one or more additional requests associated with the one or more related sub-case types, wherein each of the one or more additional requests is associated with one or more additional processes; and
populate each of the one or more additional processes with the additional information associated with the request that is retrieved by the one or more processes.

10. The system of claim 9, wherein populating each of the one or more additional requests with the additional information comprises actively populating one or more empty fields associated with the one or more additional requests with the additional information.

11. The system of claim 1, wherein the agent portal is configured to:
determine horizontal relationships, vertical relationships, or a combination thereof, between the category type and the plurality of sub-case types; and
determine one or more field mappings between the category type and the plurality of sub-case types based at least in part on the horizontal relationships, the vertical relationships, or the combination thereof.

12. The system of claim 11, wherein the one or more field mappings generate one or more field values from the selected sub-case type to one or more related sub-case types based at least in part on the horizontal relationships.

13. The system of claim 11, wherein the horizontal relationships, the vertical relationships, or the combination thereof, are dynamically updated based on changes to processes corresponding to the plurality of sub-case types.

14. A method comprising:
receiving a request from a client device, wherein the request is associated with a category type, and wherein the request is assigned to an agent;
obtaining information regarding access rights of the agent;
determining, based on the category type and the access rights, a plurality of sub-case types associated with the request; and
initiating resolution of the request based on a selected sub-case type of the plurality of sub-case types.

15. The method of claim 14, comprising:
determining a skill level associated with the agent; and
updating the plurality of sub-case types based at least in part on the skill level.

16. The method of claim 14, comprising:
generating a graphical user interface (GUI), via an agent portal, wherein the GUI includes a first drop-down menu having one or more category types including the category type for selection by the agent;
receiving, from the GUI, the category type; and
in response to receiving the category type from the first drop-down menu, unlocking the GUI to include a second drop down menu having a subset of the plurality of sub-case types for selection by the agent.

17. The method of claim 14, wherein initiating the resolution of the request comprises initiating one or more processes to retrieve additional information associated with the request.

18. The method of claim 17, comprising:
generating, in response to receiving the selected sub-case type, one or more additional requests associated with the one or more related sub-case types, wherein each of the one or more additional requests is associated with one or more additional processes; and
populating at least a portion of the one or more additional processes with the additional information associated with the request that is retrieved by the one or more processes.

19. The method of claim 18, wherein a first organization group implements the one or more processes for the selected sub-case type and a second organization group different than the first organization group implements the one or more additional processes for the one or more related sub-case types.

20. A non-transitory computer-readable storage medium storing executable instructions that, when executed by one or more processors, cause operations to be performed comprising:
receiving a request from a client device, wherein the request is associated with a category type, and wherein the request is assigned to an agent;
obtaining information regarding access rights of the agent;
determining, based on the category type and the access rights, a plurality of sub-case types associated with the request; and
initiating resolution of the request based on a selected sub-case type of the plurality of sub-case types.
